(19) United States
(12) Patent Application Publication
(10) Pub. No.: US 2014/0216131 A1
(43) Pub. Date: Aug. 7, 2014

(54) Simplified method for measuring concentrations of exhaust gas components utilizing differential measurement across an absorber

(71) Applicants: Ronald S. Patrick, Mountain View, CA (US); Robert Lupul, Mountain View, CA (US)

(72) Inventors: Ronald S. Patrick, Mountain View, CA (US); Robert Lupul, Mountain View, CA (US)

(73) Assignee: Engine Control and Monitoring, Los Altos, CA (US)

(21) Appl. No.: 13/815,147

(22) Filed: Feb. 4, 2013

(51) Int. Cl. G01M 15/10

(52) U.S. Cl. CPC G01M 15/102
USPC 73/23.31

(57) ABSTRACT

A simplified method for measuring a first property and a second property of an exhaust gas mixture utilizing two sensors manufactured for the purpose of measuring a first property, being cross-sensitive to the second property with an absorber of the second property being placed between two of the sensors in the exhausting circuit of the exhaust gas mixture. Direct differential measurement between the two sensors quantify the concentrations of the first and second property.

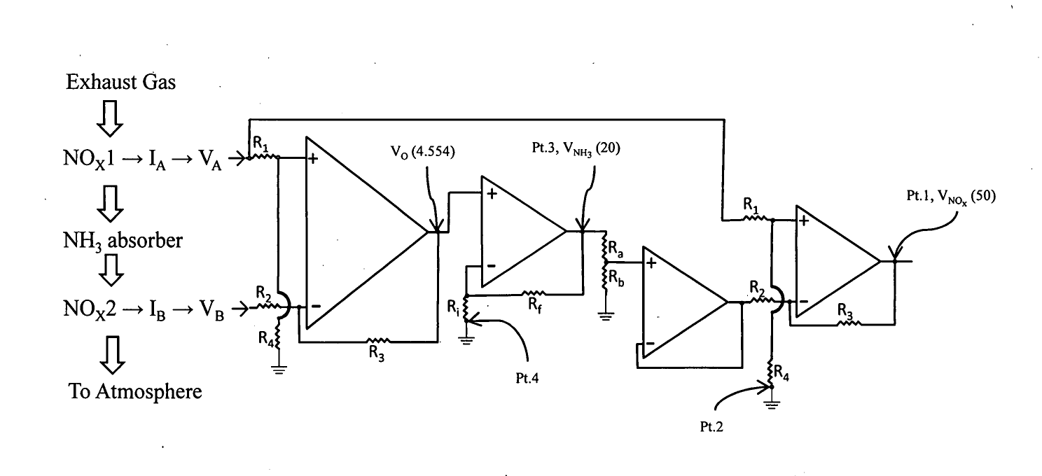

### CROSS-REFERANCE TO RELATED APPLICATIONS

The present application is submitted with reference to, and claims the benefit of, provisional patent application US 61/797,138 filed on November 30^{th}, 2012. The title of the cited provisional application is “Simplified method for measuring concentrations of exhaust gas components unitizing differential measurement across an absorber.”. The text of the first sentence following the title of the specification of the cited provisional patent application is “A simplified method for measuring a first property and a second property of an exhaust gas mixture utilizing two sensors manufactured for the purpose of measuring a first property, being cross-sensitive to the second property with an absorber of the second property being placed between two of the sensors in the exhausting circuit of the exhaust gas mixture.”.

### STATEMENT REGARDING FEDERALLY SPONSORED RESEARCH

(Not Applicable)

### BACKROUND OF THE INVENTION

Previous ceramic NOₓ sensors exhibit cross-sensitivities to NH₃. This cross-sensitivity reduces the accuracy of the reported NOₓ concentration from a sensor if NH₃ is also present in the exhaust gas mixture. The disclosed invention covers a simplified method for measuring concentrations NOₓ and NH₃ in an exhaust gas mixture. Previous inventions have required the use of more than one type of sensor (i.e. NOₓ and NH₃ sensors), or other catalytic components. One example of recent prior art (U.S. Pat. No. 7,810,313) uses at least two sensors in a system, but still requires complex algorithms and a decoupling observer module in order to quantify the relative concentrations of NOₓ and NH₃ in an exhaust gas mixture. The complexity of the above methods is unnecessary and can be reduced significantly in the non-obvious method of the disclosed invention.

### BRIEF SUMMARY OF THE INVENTION

The disclosed invention covers a simplified method for measuring concentrations NOₓ and NH₃ in an exhaust gas mixture using NOₓ sensors placed before and after an NH₃ absorber.

### BRIEF DESCRIPTION OF THE DRAWING

The enclosed drawing is a system level diagram of the preferred embodiment of the disclosed invention. Flow of exhaust gas (indicated with bold arrows) in the system as well as the points used for direct differential measurements in an electrical schematic are shown.

### DETAILED DESCRIPTION OF THE INVENTION

Two NOₓ sensors having cross-sensitivities to NH₃ are used to determine both NOₓ and NH₃ concentrations simultaneously using the disclosed method: NOₓ sensors having cross-sensitivities are placed before and after an NH₃ absorber in an exhaust gas system. A difference in readings from a first NOₓ sensor (NOₓ1) with cross-sensitivity to NH₃ and a second NOₓ sensor (NOₓ2) with a cross-sensitivity to NH₃, is determined (NOₓ1-NOₓ2). The resulting value is used to determine the NOₓ and NH₃ concentrations in the exhaust gas mixture. For example: Sensor NOₓ1 has a known, non-zero, cross-sensitivity to NH₃ of c₁ and sensor NOₓ2 has a known non-zero cross-sensitivity to NH₃ of c₂. In this case the possible NH3 cross-sensitivity values range from greater than zero to 1 (100%). A value of 1 would mean that “n” ppm of NH₃ would be reported as “n” ppm of NOₓ. A value of 0.5 would mean “n” ppm of NH₃ would be reported as “0.5×n” ppm of NOₓ. Possible NH₃ absorber effectiveness values (aₑ) are between 0 (100% of NH₃ goes though) and 1 (100% of NH₃ is absorbed). For the case of aₑ=0, c₁ cannot be equal to c₂.

Turning now to the enclosed drawing, a system with the following properties is used as an example:
Exhaust Gas: (50 ppm NOₓ & 20 ppm NH₃) with values c₁=0.32, c₂=0.71, aₑ=0.87
Direct differential measurement between Pt. 1 and Pt. 2 reads NOₓ=50 ppm
Direct differential measurement between Pt. 3 and Pt. 4 reads NH₃=20 ppm
Two NOₓ sensors (NOₓ1, NOₓ2) output current (Iₐ, I_{b}) that is translated to voltages (Vₐ, V_{b}) that are used as inputs into the system above.
R₁, R₂, R₃, R₄ chosen so that: R₁=R₂=R₃=R₄
R_{f} & Rᵢ chosen so that:

$$[ \frac{1}{( {c}_{1} - {c}_{2} ( 1 - {a}_{e} ) )} = 1 + \frac{{R}_{f}}{{R}_{i}} ]$$

Rₐ & R_{b} chosen so that:

$$\frac{{R}_{b}}{{R}_{a} + {R}_{b}} = {c}_{1}$$

Where sensor NOₓ1 having a c₁ value of 0.32 and sensor NOₓ2 having a c₂ value of 0.71 and an NH₃ absorber having aₑ value of 0.87, then NH₃ is found:

NH₃=(NOₓ1−NOₓ2)/(c₁−c₂ (1−aₑ))

NH₃=(V_{A}−V_{B})/(c1−c2 (1−aₑ))

NH₃=(56.4−51.846)/(0.32−0.71 (1−0.87))

NH₃=4.554/0.2277 or 20 ppm

### To get NOₓ:

NOₓ=NOₓ1−c₁(NH₃)

NOₓ=56.4 ppm−0.32(20)

NOₓ=50 ppm

1. A method for simultaneously measuring two properties associated with an exhaust gas mixture, said method comprising: combining at least two sensors wherein each of said sensors exhibits cross-sensitivities to a first property and a second property in said exhaust gas mixture; an absorption device selective of said second property; placement of a first of said sensors upstream from said absorption device; placement of a second of said sensors downstream of said absorption device; directly reading, between said first sensor and said second sensor, a differential value indicative of the concentration of said first property and said second property.

2. The method of claim 1, wherein said plurality of sensors comprises at least two NOₓ sensors cross-sensitive to NH₃, for detecting said first property, wherein said first property comprises a concentration of NOₓ, and said second property comprises a concentration of NH₃ in said exhaust gas mixture.

3. The method of claim 1 wherein said first property comprises NOₓ and said second property comprises NH₃.

4. A method for simultaneously measuring NOₓ and NH₃ in an exhaust gas mixture, said method comprising: the placement of at least a first NOₓ sensor upstream of a NH₃ absorber; the placement of at least a second NOₓ sensor downstream of said NH₃ absorber, wherein each of said sensors exhibits a cross-sensitivity to said NH₃; directly reading, between two of said sensors, a differential value proportional to the amount of said NOₓ and said NH₃ in said exhaust gas mixture.

5. A method for simultaneously measuring NOₓ and NH₃ in an exhaust gas mixture, said method comprising: the placement of at least one sensor upstream of an NH₃ absorber;
the placement of at least another NOₓ sensor downstream of said NH₃ absorber, wherein each of said sensors exhibits cross-sensitivities to said NOₓ and said NH₃, directly reading, between two of said sensors, a differential value proportional to the quantities of said NOₓ and said NH₃ in said exhaust gas mixture.

6. A method for simultaneously measuring NOₓ and NH₃ in an exhaust gas mixture, said method comprising: the placement of at least one sensor upstream of an NH3 absorber; the placement of at least another NOₓ sensor downstream of said NH₃ absorber, directly reading, between two of said sensors, a differential value proportional to the quantities of said NOₓ and said NH₃ in said exhaust gas mixture.

7. A method for simultaneously measuring NOₓ and NH₃ in an exhaust gas mixture in an exhaust gas system, said method comprising: a first exhausting channel and a second exhausting channel separate from said first exhausting channel in said exhaust gas system; placement of at least one sensor in said first exhausting channel, the placement of a NH₃ absorber in said second exhausting channel; the placement of at least a second sensor downstream of said NH₃ absorber in said second exhausting channel, wherein each of said sensors exhibits a known cross-sensitivity to said NOₓ and said NH₃; directly reading, between said first sensor and said second sensor, a differential value proportional to the quantities of said NOₓ and said NH₃ in said exhaust gas mixture.

8. The method of claim 2 further comprising: configuring at least one of said NOₓ sensors to comprise a zirconia-based multilayer sensing element.

9. The method of claim 1 wherein at least one of said sensors among said plurality of sensors comprises an electrically-based sensor.
